(19) United States
(12) Patent Application Publication
(10) Pub. No.: US 2020/0250665 A1
(43) Pub. Date: Aug. 6, 2020

(54) Blockchain-based electronic transaction system free of sales platform and method thereof

(71) Applicant: Eland Blockchain Fintech Inc., San Jose, CA (US)

(72) Inventors: Ching Song WU, Taipei City (TW); Chun-Wei YU, New Taipei City (TW)

(21) Appl. No.: 16/758,479

(22) PCT Filed: Oct. 2, 2018
(86) PCT No.: PCT/US18/53866

§ 371 Date: Apr. 23, 2020

Related U.S. Application Data
(60) Provisional application No. 62/576,153, filed on Oct. 24, 2017.

(51) Int. Cl. G06Q 20/38

(52) U.S. Cl. CPC G06Q 20/3829

(57) ABSTRACT

A blockchain-based electronic transaction system free of sales platform comprises a computing device. The blockchain includes a customer endpoint and a vendor endpoint, the customer endpoint and the vendor endpoint corresponding to a customer device and a vendor device, respectively. The computing device comprises a data storage module and a procurement management module. The data storage module stores at least one product sales channel public key and at least one product data. The customer device is connected to the computing device through the blockchain by a product public key of a product sales channel, and acquires the product data from the data storage module. The procurement management module is configured to enable the customer device to establish a product order message with the vendor endpoint, and to broadcast the message in the blockchain. The product order message is encrypted and authenticated by a customer private key.

### BACKGROUND OF THE INVENTION

### 1. Field of the Invention

The present invention relates to an electronic transaction system free of sales platform and a method thereof, and in particular to a blockchain-based electronic transaction system free of sales platform and method thereof.

### 2. Description of the Related Art

At present, the traditional e-commerce transactions generally has to rely on specific platform channels. The factors that ensure the operation of the platform are operation rules controlled and determined by the platform back-end itself, and mechanism functions associated with Web 2.0 technologies, and the trust toward the scale of the platform.

The most critical element of the above-mentioned operation factors is trust in scale. Due to the fact that the current networks are convenient and transparent, and information is accessible with ease, it is not easy for the average network users to establish their trusts over the platforms. However, the trust of the general users towards the platform normally follows instinct behaviors. That is, when a user faces a crisis or when he is not capable of determining the situations, he is prone to herd behavior to save time and manpower, and to reduce risk. Accordingly, such instinctive herd behavior will result in platform monopoly. In other words, when e-commerce rises in popularity, most users will be generally drawn close towards big platforms since the big platforms will normally provide interfaces with better service performance and operating experience as compared to other competitors at the early stage. Eventually, platform monopoly results. As such, the cost of entry threshold to operate and the cost to maintain subsequent operation will be high for e-commerce relying on platform channels.

Blockchain, the main technologies supporting Bitcoin and Ethereum, provides the characteristics of decentralization, globalization, without the need of a third party authority or an individual, and solves the trust issue of payment between parties. As such, it effectively provides online platform transaction with the characteristics of trust in transaction and security in information.

Therefore, there is a need to provide a novel and innovative electronic transaction system and method based on a highly reliable and secure blockchain that is free of sales platform, so as to effectively breakup monopoly in e-commerce platforms, thereby effectively lower the threshold to enter e-commerce, and provide opportunities to the transaction participants to engage in business.

### SUMMARY OF THE INVENTION

A main objective of the present invention is to provide a highly reliable and secure blockchain-based electronic transaction system and method free of sales platform, which allows each and every participant in an electronic transaction releases in a blockchain a transaction record that is consensual, authorized and authenticated, thereby improving transaction security and establish trust in scale. Consequently, not only the transaction threshold can be lowered by omitting the sales platform, but various resources can also be collected and integrated. As such, the transaction volume of e-commerce can be increased and business opportunities for the participants may be promoted.

To achieve the above object, an aspect of the present invention provides a blockchain-based electronic transaction system free of sales platform comprising a computing device, wherein the blockchain includes at least one customer endpoint and at least one vendor endpoint, the computing device is connected to the customer endpoint and the vendor endpoint through a peer-to-peer network, and the customer endpoint and the vendor endpoint respectively correspond to a customer device and a vendor device, wherein the computing device includes: a data storage module storing at least one product sales channel public key, at least one customer endpoint data, at least one vendor endpoint data, and at least one product data; wherein the customer device is connected to the computing device through the blockchain by a product public key of a product sales channel, and acquires the at least one product data from the data storage module; and a procurement management module configured to enable the customer device to establish a product order message with the vendor endpoint, and to post a corresponding record for the product order message to every node in the blockchain, wherein the product order message is encrypted and authenticated by a customer private key.

Accordingly, the blockchain-based electronic transaction system free of sales platform may provide the customer (buyer) has access to the diversified product sales channels to browse product information by a product public key via a customer device, such as electronic device, and thus will no longer be restricted by some monopolized sales platforms. In addition, through the encrypted records generated as a result of multi-parties consensus transactions between the customers (buyers) and the vendors (sellers), and the post of the encrypted records in the blockchain, the security of the transaction is ensured and the trust of the transaction participants are enhanced.

Another aspect of the present invention provides a blockchain-based electronic transaction method freed of sales platform, wherein the blockchain includes at least one customer endpoint and at least one vendor endpoint, a computing device connected to the customer endpoint and the vendor endpoint through a peer-to-peer network, the computing device stored therein at least one product sales channel public key, at least one customer endpoint data, at least one vendor endpoint data, and at least one product data; the customer endpoint and the vendor endpoint corresponding to a customer device and a vendor device, respectively; the electronic transaction method comprises the following steps: step (A): the customer device acquires a product public key from a product sales channel, and is connected to the computing device through the blockchain by the product public key to acquire the product data; and step (B): the customer device establishes a product order message with the vendor endpoint through the computing device, and posts the product order message to every node; the product order message and the shipping message include the customer endpoint data and the vendor endpoint data, wherein the product order message is encrypted and authenticated by the customer private key.

The above-stated blockchain-based, sales platform-free electronic transaction method enables the customers (buyers) and the vendors (sellers) to establish and complete the transaction in the diversified product sales channel, and the consensus record encrypted and authenticated by the participants in the blockchain will secure the transaction and provide trust.

### BRIEF DESCRIPTION OF THE DRAWINGS

FIG. 1A is a schematic diagram of a blockchain-based electronic transaction system free of sales platform according to an embodiment of the present invention;

FIG. 1B is a functional block diagram of a procurement management module according to an embodiment of the present invention;

FIG. 1C is a functional block diagram of a computing device according to another embodiment of the present invention;

FIG. 1D is a functional block diagram of a shipment management module according to another embodiment of the present invention.

FIG. 2A is a flow chart of an electronic transaction method according to an embodiment of the present invention, which is based on a blockchain and free of sales platform;

FIG. 2B is a flow chart of an electronic transaction method based on a blockchain and free of sales platform according to another embodiment of the present invention;

FIG. 2C is a schematic diagram of an electronic transaction method based on a blockchain and free of sales platform according to an embodiment of the invention;

FIG. 3 is a schematic diagram showing that a participant of a transaction establishes consensus and verification by a blockchain according to an embodiment of the present invention.

### DESCRIPTION OF THE PREFERRED EMBODIMENTS

The present invention is related to a blockchain-based electronic transaction system free of sales platform. In the description, similar elements will be denoted by the same reference numerals. In addition, the drawings of the present invention are only intended to be illustrative, and are not necessarily drawn to scale, and all details are not necessarily be shown in the drawings.

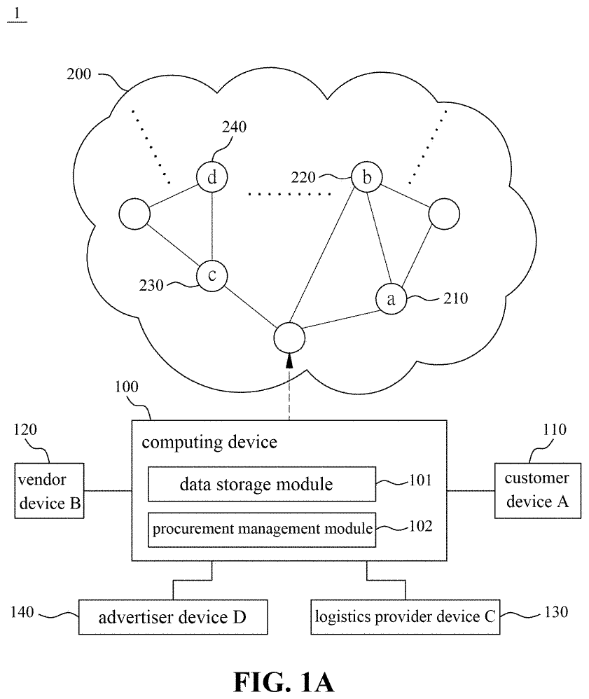

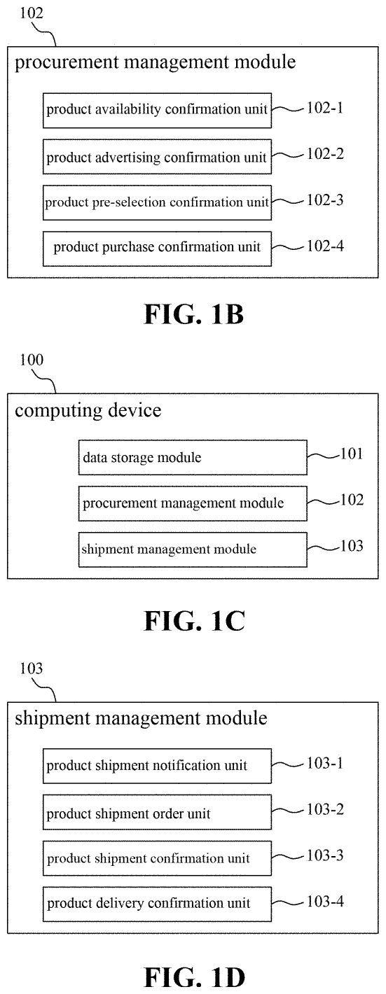

Please refer to FIG. 1A, which is a schematic diagram of a block-chained electronic transaction system free of sales platform according to an embodiment of the present invention. As shown, an electronic transaction system 1 based on a blockchain 200 and free of sales platform includes a computing device 100, wherein the blockchain 200 includes at least one customer endpoint 210 and at least one vendor endpoint 220. The computing device 100 is connected with the customer endpoint 210 and the vendor endpoint 220 through a peer-to-peer network, and the customer endpoint 210 and the vendor endpoint 220 are, respectively, associated with a customer device 110 and a vendor device 120. Both the customer endpoint 210 and the vendor endpoint 220 can be considered as individual accounts for buyers and sellers, respectively, in the blockchain.

The computing device 100 may include a data storage module 101 and a procurement management module 102. The data storage module 101 is configured to store at least one product sales channel public key, at least one customer endpoint data, at least one vendor endpoint data, and at least one product data. The customer device 110 is connected to the computing device 100 in the blockchain 200 by a product public key of a product sales channel (for example, browsing pages of the network product advertisement, QR codes and Bar codes in paper form), and acquires at least one product data from the data storage module 101. The data storage module 101 may include a product information database, which is used to store related sales information of the product, such as specifications and photos of the product. In addition, the data storage module 101 can further include user information database which may include customer or buyer's receiving address contact information and vendor or seller's pick-up address contact information.

On the other hand, the procurement management module 102 is configured to provide the customer device 110 to establish a product order message with the vendor endpoint 220, and post the product order message in every node of the blockchain 200, wherein the product order message is encrypted and authenticated by the customer's private key. In other words, the customer (buyer) can post a purchase record to the vendor (seller) in the blockchain 200 through the customer device 110 and through the message delivery process of the procurement management module 102.

Referring to FIG. 1B which shows a functional block diagram of the procurement management module 102 according to an embodiment of the present invention. As shown in the figure, the procurement management module 102 can further include a product availability confirmation unit 102-1 to confirm the vendor device 120 that the product has been put on sale, and correspondingly generate a put on sale message for the product, and post a corresponding record in each node of the blockchain 200, wherein the put on sale message is encrypted and authenticated by a vendor private key. Every product has a corresponding product public key.

In this way, the transaction of the put on sale product can be executed by the product availability confirmation unit 102-1. In other words, the vendor (seller) can complete the act of putting a product on sale by posting a corresponding record to the public key of the product to be on sale in the blockchain 200 by the product availability confirmation unit 102-1.

Now referring to FIGS. 1A and 1B, the procurement management module 102 may further include a product advertising confirmation unit 102-2 for enabling the advertiser device to access the advertiser endpoint 240 in the blockchain by a product public key, so as to browse the product information provided by the vendor (seller), and to select products of highly competitive in the marketplace or of high cost-performance ratios, and then post the selected products in the product sales channel of the advertisers. In this way, the vendor (sellers) can focus on the development and promotion of the products to attract the advertisers to take the initiative to promote the products, thus saving additional costs for commercials. In the meantime, advertisers can also create business opportunities for themselves. For example, when a customer (buyer) confirms his or her purchase of a product, the information associated with the record posted in the blockchain by the customer device will have the public key of the advertiser, As such, when the transaction is successfully done, the advertiser can get the profit by proportion.

The procurement management module 102 may further include a product pre-selection confirmation unit 102-3, so that the customer (buyer), in the process of browsing the product online, can directly place a desired product in the pre-selected list, for example, a shopping cart, through the customer device 110 for further consideration before purchasing the product. More particularly, the product pre-selection confirmation unit 102-3 is configured to enable the customer device 110 to generate a product pre-selection message according to at least one product data, and post the product pre-selection message and the public key associated with the product sales channel to every node of the blockchain 200, wherein the product pre-selected message is encrypted and authenticated by the customer private key of the customer device 110.

Furthermore, the procurement management module 102 may further include a product purchase confirmation unit 102-4 for confirming with the vendor (seller) the shopping list that lists the final favorite products selected from the shopping cart for settlement. In particular, the product purchase confirmation unit 102-4 is configured to enable the customer device 110 to confirm the items and the quantity of the final favorite products the customer decides to place order according to the product pre-selection message, and generate a corresponding product purchase message and post a corresponding record in every node, wherein the product purchase message is encrypted and authenticated by the customer's (buyer's) private key.

FIGS. 1C and 1D illustrate functional block diagrams of the computing device 100 and the shipment management module 103 thereof according to another embodiment of the present invention. The computing device 100 further includes a shipment management module 103 for enabling a logistics provider to locate logistics orders in the blockchain 200, from which a logistics order that is suitable for the logistics provider to handle can be selected, so as to carry out the cargo delivery based on the order. In particular, the shipment management module 103 includes a product shipment notification unit 103-1 for providing at least one logistics provider device 130 with the customer's public key and the vendor's public key, so that a shipment message associated with the product order message may be acquired from the corresponding logistics provider endpoint 230 in the blockchain 200. Thus, the at least one logistics provider device 130 may acquire the information regarding specifications and shipment quantity of the products, customer's contacts for accepting delivery, and vendor's contacts for picking up delivery from the data storage module based on the shipment message.

The shipment management module 103 further includes a product shipment order unit 103-2 and a product shipment confirmation unit 103-3. The product shipment order unit 103-2 is configured to provide the logistics provider device 130 to generate a logistics order message and post a corresponding record in every node, wherein the logistics order message is encrypted and authenticated by the logistic provider's private key. In this way, after the logistics provider locates a shipment message that meets his requirement through the shipment provider device 130, he can then post a logistics order message for confirmation in the blockchain 200 through the product shipment order unit 103-2 to submit a contract offer for the logistics transaction.

On the other hand, the product shipment confirmation unit 103-3 is configured to enable the vendor device 120 to generate a corresponding product delivery message after confirming that the logistics provider has issued an order message to receive the order, and post a corresponding record in every node of the blockchain 200, wherein the product delivery message is encrypted and authenticated by the vendor's private key. As such, after the logistic transaction has been signed by both the logistics provider's private key and the vendor's private key, the requirements that are mutually agreed upon by both parties can be met, and thus the rights and obligations of both parties associated with the logistics transaction can be effectively secured.

Furthermore, the shipment management module 103 may further include a product delivery confirmation unit 103-4. When the logistics provider has delivered the product to the customer (buyer) or the recipient's address designated by the customer, the client device 110 will generate a product-received message that is encrypted and authenticated by the customer's private key, and post the record in every node of the blockchain 200 to complete the entire transaction. In particular, the product delivery confirmation unit 103-4 is configured to provide the client device 110 to generate a message confirming the receipt of the product, and to post a corresponding record in every node of the blockchain 200, wherein the message confirming the receipt of the product is encrypted and authenticated by the customer's private key.

When it is confirmed that the product has been delivered to the customer (buyer) and the transaction completed, the payment gateway will confirm the completion of the transaction from the blockchain 200, and then make payment according to the customer's (buyer's) product transaction option. The payment can be made directly through bank, third party payment or P2P consumer loan.

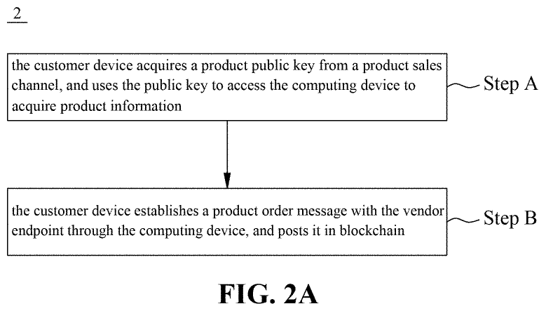

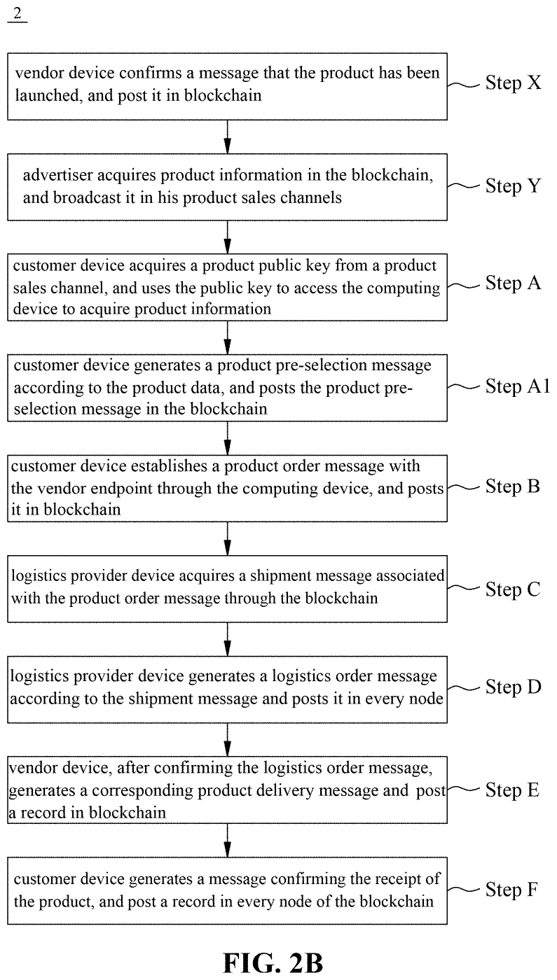

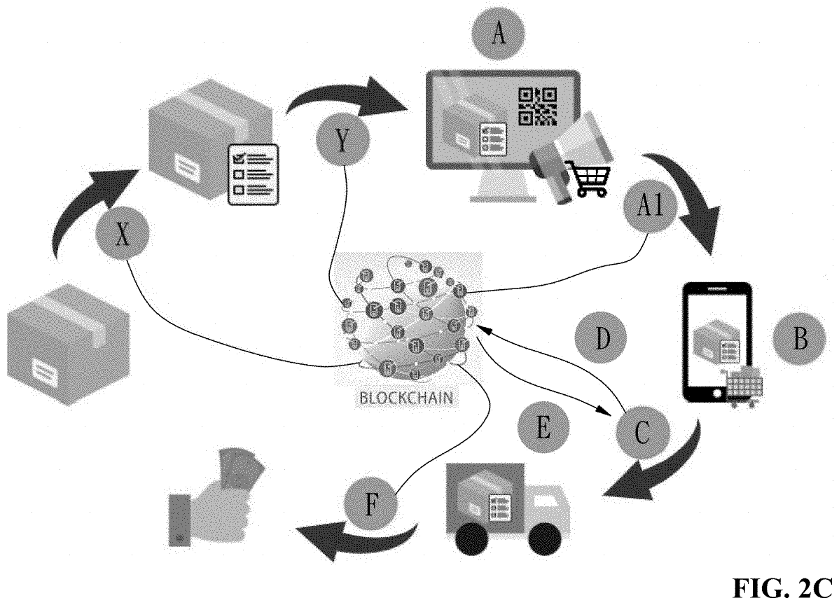

Referring to FIGS. 2A and 2C, which illustrate, respectively, a flow chart and a schematic diagram of an electronic transaction method 2 based on a blockchain and having no sales platform according to an embodiment of the present invention. The electronic transaction method 2 is applicable to the electronic transaction system 1 mentioned hereinabove that is based on a blockchain 200 and omits sales platform. As shown in the drawings, the electronic transaction method 2 comprises the following steps: step (A): the customer device 110 acquires a product public key from a product sales channel. For example, the customer (buyer) can access the client device 110 (for example, an electronic mobile device) to scan the product's QR code available on the internet media or the hard copy flyer so as to acquire a corresponding product public key. The customer may then connect the computing device 100 through the blockchain 200 by the product public key, thereby obtains the product information pre-stored by the vendor (seller) via the data storage module 101; and step (B): after the customer device 110 have selected the product needed and to buy, a product order message is established with the vendor endpoint 220. The product order message is then posted in every node of the blockchain 200, wherein the product order message is encrypted and authenticated by the customer private key.

FIG. 2B illustrates a flowchart of an electronic transaction method 2 based on a blockchain and having no sales platform according to an embodiment of the present invention. As shown in the figure, after step (A) of browsing the product in the product sales channel, the electronic transaction method may further include a product pre-selection step (A1) which enables the customer device 110 to generate a product pre-selection message based on the product data. In other words, the customer (buyer), in the process of browsing the products online, may directly place a desired product in the shopping cart, so that a shopping list of intended products is provided for further consideration before purchasing. Further, the product pre-selection message and the public key associated with the product sales channel are posted in every node of the blockchain 200, wherein the product pre-selection message is encrypted and authenticated by the customer private key of the customer device 110.

On the other hand, before step (A) of browsing the product through the product sales channel, the electronic transaction method 2 may further include step (X) of putting the product on sale. Further, in step (X), the vendor device 120 confirms the message about the availability of the product, and correspondingly generates a product on sale message and posts a corresponding record in every node of the blockchain 200, wherein the product on sale message is encrypted and authenticated by a vendor private key of the vendor device 120.

Then, after the product on sale step (X), the electronic transaction method 2 may include a product publication step (Y), so that the advertiser can access the advertiser device in the blockchain by a product public key to select products of highly competitive in marketplace or of high cost-performance ratios, and then post the selected products in the product sales channels of the advertisers. In this way, vendors (sellers) can focus on the development and promotion of the products, so that the products have market value to attract the advertisers to do the promotion, thereby omit the need to pay extra commercial fees, and to put special efforts to do product advertising. In the meantime, the advertisers can also create business opportunities for themselves.

Referring to FIG. 2B again, after the product purchase confirmation step (B), the electronic transaction method 2 may further include a logistics transaction inquiry step (C). In step (C), at least one logistics provider device 130 obtains a shipment message of the product order message through the blockchain 200, and the logistics provider device 130 is authenticated or authorized, wherein the shipment message includes the information such as model, specification, quantity to be shipped, customer's contacts for accepting delivery, and vendor's contacts for picking up products.

Subsequently, after the logistics transaction inquiry step (C), the electronic transaction method 2 may further comprise step (D) of transmitting the delivery intention. In particular, in step (E), at least one logistics provider device 130 generates a logistics order message according to the shipment message and posts a corresponding record in every node, wherein the logistics order message is encrypted and authenticated by the logistics provider private key.

Next, after step (D), the electronic transaction method 2 may comprise step (E) of confirming the delivery of the order, so that the logistics provider and the vendor (seller) reach a consensus, and the logistics provider accepted by the vendor will deliver the product to the customer (buyer). Further, in step (E), the vendor device 120, after confirming the logistics order message, will correspondingly generate a product delivery message and post a corresponding record in every node of the blockchain 200, wherein the product delivery message is encrypted and authenticated by the vendor's private key of the vendor device 120.

The electronic transaction method 2 may, after confirming the order delivery step (E), comprises step (F) of confirming the receipt of the product, so that after the product has been delivered to the customer (buyer) via the logistics provider, the customer will send a confirmation message to notify the completion of the transaction. In particular, in step (F) of confirming the receipt of the product, when the customer receives the product, the customer device 110 will generate a product received confirmation message and posts a corresponding record in every node of the blockchain 200, wherein the product received confirmation message is encrypted and authenticated by the customer's private key of the customer device 110.

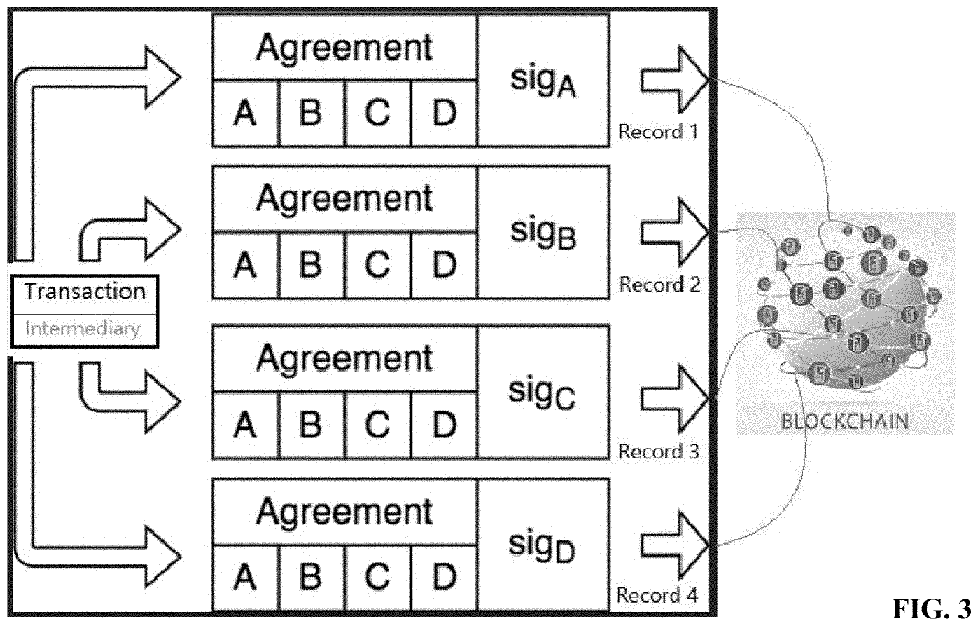

FIG. 3 is a schematic diagram showing that a participant of a transaction establishes consensus and verification by a blockchain. As shown in the drawing, according to the blockchain-based electronic transaction system 1 and method 2 free of sales platform as disclosed in the above embodiment, each and every participant that participates in the product transaction, that is, the customer (buyer), the vendor (seller), logistics provider and advertiser may establish consensus among themselves in every transaction through their respective counterparts (for example, customer device A, vendor device B, logistics provider device C, and advertiser device D). Each and every confirmation message is encrypted and authenticated by the private key of each participant, and is broadcasted in the blockchain to be stored as a permanent record that cannot be altered retroactively, and is verified by the nodes in the blockchain, thereby effectively improve transaction security and reliability.

The preferred embodiments of the present invention are illustrative only, and are not limited to the details disclosed in the drawings and the specification. Many changes can be made by those having ordinary skill in the art without departing from the equivalent changes and modifications made by the claims of the present invention, and should belong to the scope of the prevent invention.

What is claimed is:

1. A blockchain-based electronic transaction system free of sales platform comprising: a computing device, wherein the blockchain includes at least one customer endpoint and at least one vendor endpoint, the computing device being connected to the customer endpoint and the vendor endpoint through a peer-to-peer network, the customer endpoint and the vendor endpoint corresponding to a customer device and a vendor device, respectively, wherein the computing device comprises:
a data storage module configured to store at least one product sales channel public key, at least one customer endpoint data, at least one vendor endpoint data, and at least one product data; wherein the customer device is connected to the computing device through the blockchain by a product public key of a product sales channel, and acquires the at least one product data from the data storage module; and
a procurement management module configured to enable the customer device to establish a product order message with the vendor endpoint, and to broadcast a corresponding record for the product order message to every node in the blockchain, wherein the product order message is encrypted and authenticated by a customer private key.

2. The electronic transaction system of claim 1, wherein the procurement management module further comprises a product pre-selection confirmation unit configured to enable the customer device to generate a product pre-selection message according to the at least one product data, and to post a corresponding record for the product pre-selection message and the product sales channel public key corresponding to the product sales channel to every node in the blockchain, wherein the product pre-selection message is encrypted and authenticated by the customer private key.

3. The electronic transaction system of claim 1, wherein the procurement management module further comprises a product availability confirmation unit for the vendor device to confirm the message that the product has been launched, and correspondingly generate a put on sale message for the product and post a corresponding record in every node, wherein the put on sale message is encrypted and authenticated by a vendor private key.

4. The electronic transaction system of claim 1, wherein the procurement management module further comprises a product purchase confirmation unit for the customer device to confirm the product pre-selection message, and correspondingly generate a product purchase message and post a corresponding record in every node, wherein the product purchase message is encrypted and authenticated by the customer private key.

5. The electronic transaction system of claim 1, wherein the computing device further comprises a shipment management module having a product shipment notification unit configured to enable at least one logistics provider device to acquire a shipment message associated with the product order message through the blockchain, thereby allowing the at least one logistics provider device to acquire the information such as model, specification, quantity to be shipped, customer's contacts for accepting delivery, and vendor's contacts for picking up products from the data storage module.

6. The electronic transaction system of claim 1, wherein the shipment management module comprises:
a product shipment order unit configured to enable the logistics provider device to generate a logistics order message and post a corresponding record in every node, wherein the logistics order message is encrypted and authenticated by the logistic private key; and
a product shipment confirmation unit configured for the vendor device to generate a corresponding product delivery message and post a corresponding record in every node of the blockchain after the logistics order message is confirmed, wherein the product delivery message is encrypted and authenticated by the vendor private key.

7. The electronic transaction system of claim 5, wherein the shipment management module further comprises a product receipt confirmation unit configured to enable the customer device to generate a message confirming the receipt of the product, and post a corresponding record in every node of the blockchain, wherein the product receipt confirmation message is encrypted and authenticated by the customer private key.

8. A blockchain-based electronic transaction method freed of sales platform, wherein the blockchain includes at least one customer endpoint and at least one vendor endpoint, a computing device connected to the customer endpoint and the vendor endpoint through a peer-to-peer network, the computing device stored therein at least one product sales channel public key, at least one customer endpoint data, at least one vendor endpoint data, and at least one product data; the customer endpoint and the vendor endpoint corresponding to a customer device and a vendor device, respectively; the electronic transaction method comprises the following steps:
(A) the customer device acquires a product public key from a product sales channel, and is connected to the computing device through the blockchain by the product public key to acquire the product data;
(B) the customer device establishes a product order message with the vendor endpoint through the computing device, and posts the product order message to every node; the product order message and the shipping message include the customer endpoint data and the vendor endpoint data, wherein the product order message is encrypted and authenticated by the customer private key.

9. The electronic transaction method of claim 8, further comprising step (A1) following step (A), wherein in step (A1), the customer device generates a product pre-selection message according to the product data, and posts the product pre-selection message and a product sales channel public key corresponding to the product sales channel to every node in the blockchain, wherein the product pre-selection message is encrypted and authenticated by the customer private key.

10. The electronic transaction method of claim 8, further comprising step (X) preceding step (A), wherein in step (X), the vendor device confirms a message that the product has been launched, and correspondingly generates a put on sale message for the product and post a corresponding record in every node, wherein the put on sale message is encrypted and authenticated by a vendor private key.

11. The electronic transaction method of claim 8, further comprising step (C) following step (B), wherein in step (C), at least one logistics provider device acquires a shipment message associated with the product order message through the blockchain, wherein the shipment message includes the information such as model, specification, quantity to be shipped, customer's contacts for accepting delivery, and vendor's contacts for picking up products.

12. The electronic transaction method of claim 11, further comprising step (D) following step (C), wherein in step (D), at least one logistics provider device generates a logistics order message according to the shipment message and posts a corresponding record in every node, wherein the logistics order message is encrypted and authenticated by the logistic private key.

13. The electronic transaction method of claim 12, further comprising step (E) following step (D), wherein in step (E), the vendor device generates a corresponding product delivery message and posts a corresponding record in every node of the blockchain after the logistics order message is confirmed, wherein the product delivery message is encrypted and authenticated by the vendor private key.

14. The electronic transaction method of claim 13, further comprising step (F) following step (E), wherein in step (F), the customer device generates a product receipt confirmation message, and posts a corresponding record in every node of the blockchain, wherein the product receipt confirmation message is encrypted and authenticated by the customer private key.
